(19) United States
(12) Patent Application Publication
(10) Pub. No.: US 2004/0256766 A1
(43) Pub. Date: Dec. 23, 2004

(54) Method and apparatus for forming containers

(76) Inventors: Primo Finetti, Mirandola (IT); Andrea Bartoli, Reggio (IT)

Correspondence Address: NIXON & VANDERHYE, PC, 1100 N GLEBE ROAD, 8TH FLOOR, ARLINGTON, VA, 22201-4714, US

(21) Appl. No.: 10/496,563

(22) PCT Filed: Nov. 25, 2002
(86) PCT No.: PCT/EP02/03241

(30) Foreign Application Priority Data
Nov. 23, 2001 (IT) MO2001A000230

(51) Int. Cl. B29C 51/00

(52) U.S. Cl. 264/322; 425/384

(57) ABSTRACT

A method for forming containers (C) comprises advancing a web material (2) along an advancing direction (F) to at least one operating stations (4, 5, 6, 7) in which at least one strip of containers (C) is formed from said web material (2), heating said web material (2) in said at least one operating station (4, 5, 6) by means of at least one heating element (41, 51, 61) and injecting a cooling gas through at least one space comprised between said web material (2) and said heating element (41, 51, 61); an apparatus for forming containers (C) comprises a feeding line for advancing a web material (2) along an advancing direction (F), at least an operating station (4, 5, 6, 7) arranged along said feeding line to form a strip of containers (C) from said web material, at least one heating element (41, 51, 61) for heating said web material (2) and injecting means (9) for injecting at least one cooling gas through at least one space comprised between said web material (2) and said at least one heating element (41, 51, 61).

This invention concerns a method and an apparatus for forming a strip of containers.

Specifically, but not exclusively, the present invention can be used to form one or more strips of containers in thermosealable and thermoformable plastic material.

In particular, the invention refers to a method and to an apparatus according to the preamble of the first and thirteen claims respectively.

According to prior art, strips of containers in thermosealable and thermoformable plastic material are formed by advancing one or more continuous strips through various operating stations arranged in succession, generally one or more pre-heating stations, a sealing station and a forming station. The strips are indexed through the operating stations and during each wait period of the indexing the pre-heating, sealing and forming half moulds are closed to operate on the strips; after operating the half moulds are opened to allow the strips to be indexed again.

A prior art drawback is that the strips, during advancing through the operating stations in which heat is generated (e.g. the pre-heating stations or the sealing station), can be damaged by the heat itself, especially if the strips are kept stationary, for a shorter or longer pause, at the stations themselves. In this case, when operations are resumed after the pause, there is an initial transitory period in which forming of the first containers is imperfect and leads to production rejects.

An object of the present invention is to improve known container forming apparatus.

An advantage of the invention is to ensure regular forming of the containers and minimise the formation of rejects, even if the work process is interrupted.

Another advantage is that a reliable apparatus is supplied that is constructionally simple and economic.

A further advantage is that a method and apparatus are made available that ensure, after even a prolonged period of interruption of the operating process, a fully efficient resumption right from the start.

These object and advantages are achieved by this invention, as is specified by the claims below.

Further features and advantages of the present invention will become apparent from the following detailed description of preferred embodiments of the invention shown by way of non-limitative example in the attached drawings.

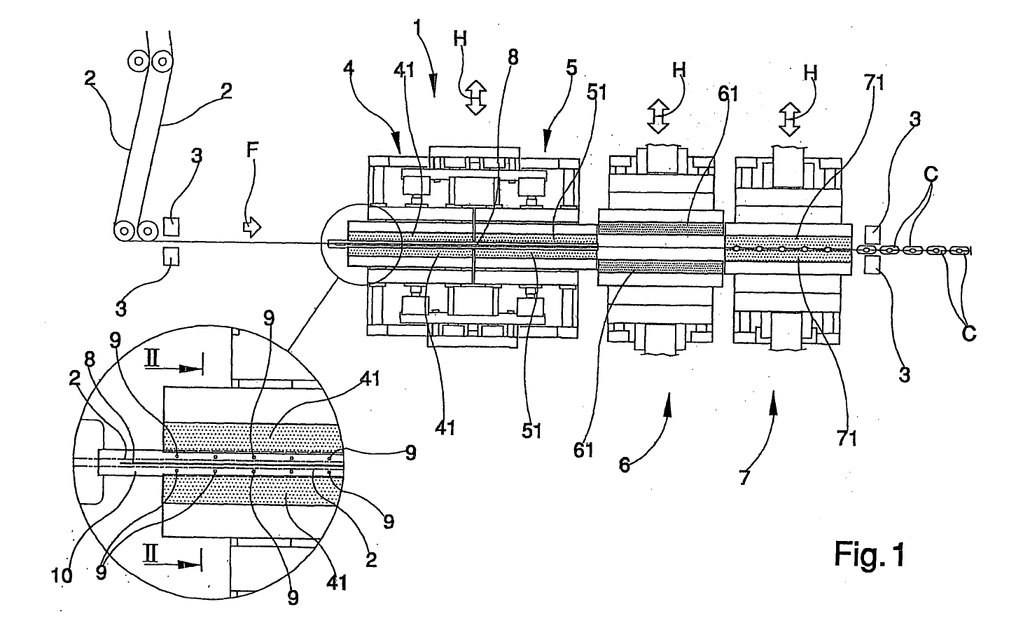

FIG. 1 is a top plan view from above of a part of the apparatus in subject;

FIG. 2 shows a cross-section taken along plane II-II of FIG. 1 showing injecting means of the apparatus arranged below the web material;

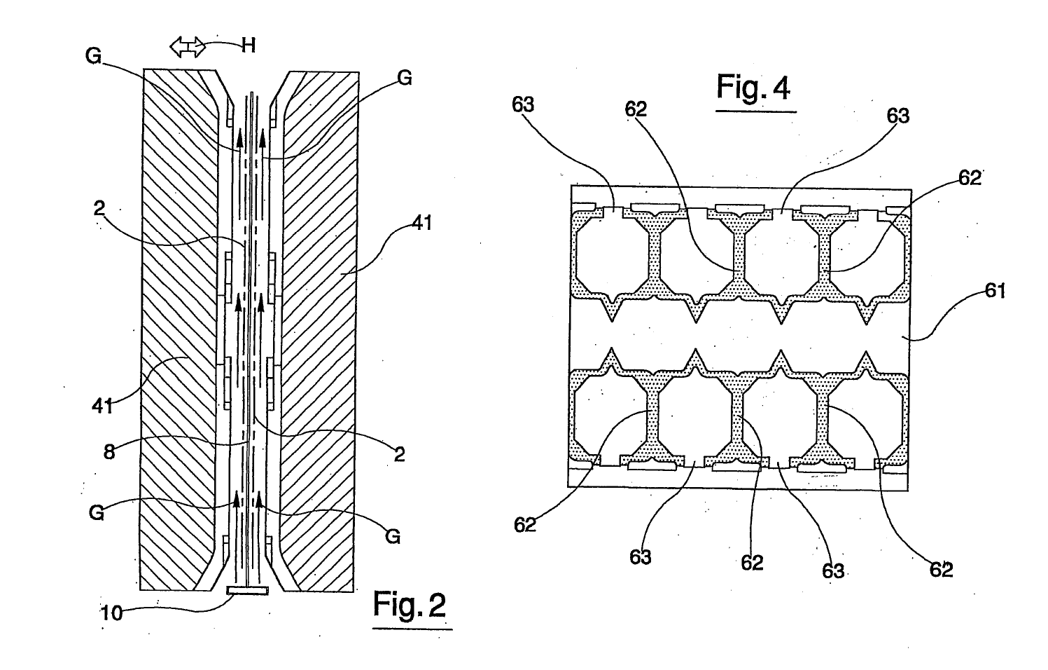

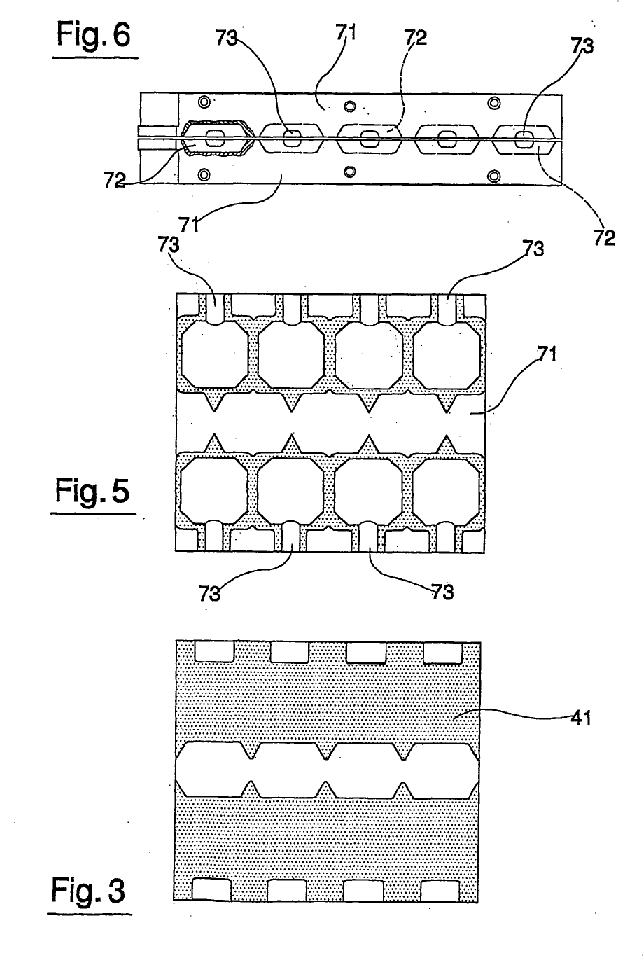

FIG. 3 is a front view of a pre-heating half mould of the apparatus of FIG. 1;

FIG. 4 is a front view of a sealing half mould of the apparatus of FIG. 1;

FIG. 5 is a front view of a forming half mould of the apparatus of FIG. 1;

FIG. 6 is a view from above, with some cross-sectioned parts, of a pair of forming half moulds in a closed configuration;

FIG. 7 is a cross-section like that of FIG. 2 showing the injecting means arranged above the web material;

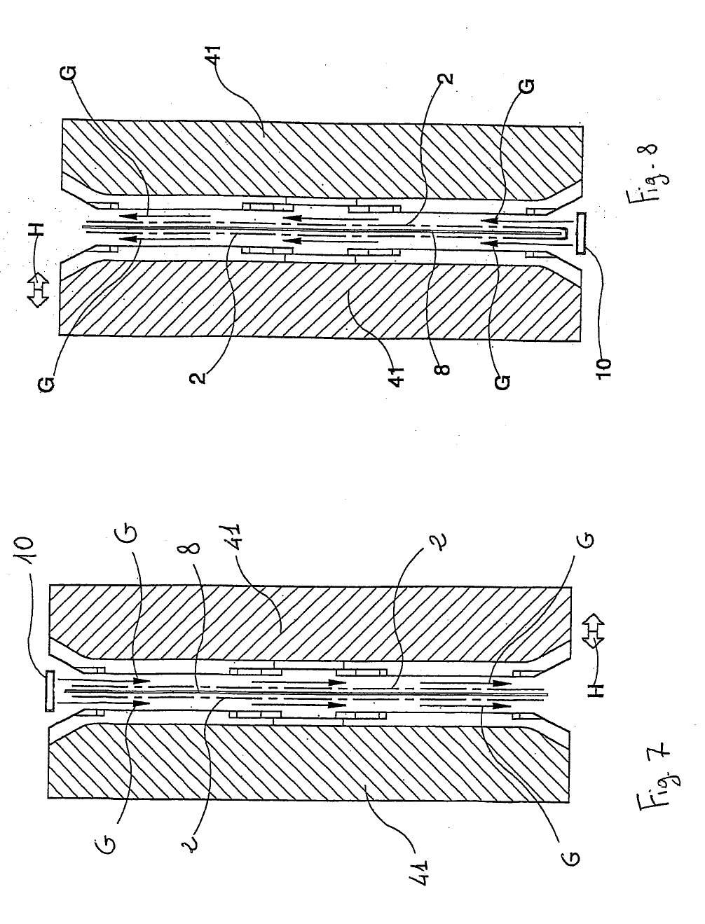

FIG. 8 is a cross section like that of FIG. 2 showing a web material folded along a longitudinal axis thereof so as to obtain a pair of facing portions.

With reference to FIGS. 1 to 8, an apparatus 1 is shown for forming a strip of containers C.

The apparatus 1 comprises a feeding line for feeding, according to an advancing direction F, at least two continuous webs 2 of material, each in the form of relatively thin film, which advance facing each other. The material of the webs 2 is preferably thermosealable and thermoformable plastic material. Each web 2 is unwound from a relative reel (not shown). The webs 2 are indexed in a direction F, being dragged by moving means constituted, for example, by pairs of jaws 3 that can be moved forwards and backwards and which are arranged for gripping the webs 2 in the forward movement and release them in the return movement.

As shown in FIG. 8, the apparatus 1 may be fed with a single web 2 folded along a longitudinal axis thereof so as to form a pair of facing portions.

The apparatus 1 comprises a plurality of operating stations arranged along the feeding line to transform the two webs 2 into a continuous strip of containers C. In this case the operating stations are, in succession, two pre-heating stations 4 and 5 for pre-heating the webs, a sealing station 6 and a forming station 7.

At least one operating station is provided with at least one heating element that is operationally associated with at least one web. In the specific case the two pre-heating stations 4 and 5 and the sealing station 6 are each provided with a pair of heating elements opposite each other that perform operations on the webs 2 (in particular pre-heating and heat-sealing) by means of which the webs are heated. Each of these heating elements consists, in this particular case, of a half mould (pre-heating half mould 41 and 51 or sealing half mould 61) that operates in contact with the webs 2 in preset zones. The heated zones of the pre-heating half mould 41 in FIG. 3 are filled with pockmarking.

The forming station 7 also comprises two half moulds 71 opposite to each other, which, when they are brought together, form one or more forming cavities 72 (the forming cavities are in this case arranged in two superimposed rows) in which the containers are thermoformed. Each forming cavity 72 is provided with an inlet 73 for blowing a forming fluid.

In the sealing station 6 the webs 2 are heat-sealed in preset sealing zones to define pockets, each of which has at least one opening; by way of example, in FIG. 4 reference 62 shows operating zones, filled with pockmarking, of the half mould 61 in which sealing of the webs 2 takes place and reference 63 shows the zones in which the openings of the pockets are formed. In the forming station 7 a forming fluid is injected into the pockets through the above mentioned openings (by means of nozzles inserted into said openings) to expand the pockets inside the forming cavities. The blowing means for blowing the forming fluid (in general compressed air) is known and is not shown.

Each pair of half moulds 41, 51, 61, 71, in each operating station, can be moved between a first closing position in which the half moulds operate on the webs 2 (preferably in contact with said webs) and a second opening position in which they are removed from the webs. The approach and removal movement in a direction indicated by the reference H is at right angles with respect to the advancing direction F of the webs 2 and the exiting direction G of a cooling fluid. In FIG. 1, by way of example, the forming station 7 is shown with the half moulds 71 closed, i.e. when they are operating on the webs 2 near the webs to define the forming cavity 72, whereas the pre-heating stations 4 and 5 and the sealing station 6 are shown with the half moulds 4, 5 and 6 open, i.e. far from the webs 2.

Each pre-heating station 4 and 5 comprises a separating wall 8 arranged between the webs 2 to prevent their coming into contact with each other and the direct transmission of heat between said webs during pre-heating.

The apparatus 1 comprises injecting means for injecting a flow of cooling gas through a space between each web 2 and the heating element (in the case in point the pre-heating half mould 41 and 51 or sealing mould 61) facing the web and arranged in the second, inactive, opening position.

Said injecting means comprises, for each web 2, one or more outlets for the pressurised cooling gas that are arranged parallel to the web. In the case in point, as shown in the enlarged drawing in FIG. 1, the outlet for the cooling gas (e.g. compressed air at ambient temperature) consists of a plurality of discrete outlet ports 9 arranged in a row. In other embodiments that are not shown, one or more outlets having a linear shape can be provided. The outlet for the cooling gas, distributed lengthwise to create an “aeriform wall” protecting the web 2, is located immediately to the side of an end of the web 2; in the preferred embodiment shown in FIG. 2, the outlet is located below the bottom end of the web; the two flows of cooling gas (one for each web) are directed upwards in a blowing direction G that is perpendicular to the advancing direction F. Each cooling flow crosses the entire operating station (pre-heating stations 4 and 5 and sealing station 6) in an upward direction to exit from the top in the upper zone of the station, at the end of the web opposite the one from which the flow leaves.

The injecting means may also be arranged above the webs 2, as shown in FIG. 7.

Each gas outlet 9 is arranged at the end of a nozzle (not shown) connected to a collector 10, which is the same for all the outlets 9 of both rows, which collector 10 extends lengthwise parallel to the webs and to which the separation wall 8 is firmly connected.

The collector 10 may also be separated from the separation wall 8, as shown in FIGS. 7 and 8.

The outlets 9 for the cooling gas extend lengthwise in direction F to operate both at the two pre-heating stations 4 and 5, and at the sealing station 6; other embodiments can be provided in which said outlets, from which the cooling flow come out, are arranged only in the pre-heating zone or only in the sealing zone.

The flow of cooling gas is preferably formed of compressed air or another inert pressurised gas.

At the pre-heating stations 4 and 5 the outlets 9 are located in such a way as to generate two flows (substantially arranged as two fluid walls protecting the webs 2) with direction G, parallel to each other, each of which passes between a web 2 and the pre-heating half mould 41 in the opening position, with the webs 2 being separated from each other by the separation wall 8. At the sealing station 6 the outlets are arranged in such a way as to generate two flows (which are also substantially arranged as two fluid walls protecting the two opposite sides of the webs 2 sealed together), each of which passes between the webs 2, that are preferably already coupled by sealing and form a single strip, and the sealing half moulds 61 located in the opening position.

The apparatus 1 described above carries out, during working, a method for forming a continuous strip of. containers C, according to which the two continuous webs 2 of material in the form of a film are indexed, the one facing the other, first passing through the pre-heating stations 4 and 5 and then through the sealing station 6 and finally through the forming station 7, from which a single strip of formed containers C emerges, which containers are intended for subsequent processing (said processing generally involves at least the filling and sealing of the containers C in a strip, and finally the cutting of the strip into sections comprising several containers C or into single containers C).

When the operating procedure of the apparatus 1 is interrupted for any reason (even for just a few seconds or even for a much more prolonged period) the injecting means for injecting the cooling gas is actuated (preferably automatically as soon as the interruption of the productive process is detected, for example, by means of a sensor), which generates at least one aeriform flow that acts as a fluid protective barrier placed between at least one web 2 and the heating element (in this case a pre-heating half mould 41 and 51 or a sealing half mould 61) that is operationally associated with the web 2, with the main purpose of preventing the web that is stationary in front of the heating element from overheating because it is exposed too long to the heat given off by said element. This injection phase, which in the case in point creates two fluid barriers (each in the form of a sort of wall created by an air current) protecting the webs, is provided during a period of interruption of the forming of the containers C and of the indexing of the webs 2. The flow of cooling gas is preferably injected with direction G transversal to the web advancing direction F.

The cooling gas keeps the webs 2 in the same thermo-physical condition as normal operating conditions for a long time, i.e. in a condition that is suitable for continuing normally the forming process immediately upon the new start of the procedure after the interruption, without any transitory period before the return to the normal operating situation.

At the restart, the first operations should preferably be pre-heating and sealing of the parts of the webs that during the interruption faced the relative heating elements (pre-heating and sealing half moulds), after which the webs are advanced by one step and the regular and normal operating process is conducted. Substantially, the interruption should preferably start immediately after the advance of the webs by one step and the restart should preferably begin (not with the advance of the webs but) with the operations that heat the webs (which operations in the case described above being pre-heating and sealing).

Numerous practical applicative modifications of constructional details can be applied to the apparatus without departing from the scope of the invention claimed below.

1-22. canceled.

23. Method for forming containers, comprising advancing web material along an advance direction across at least one heating station provided with heating device and one forming station in which containers are formed from said web material, and further comprising injecting cooling fluid between said web material and said heating device.

24. Method according to claim 23, wherein said injecting comprises injecting a gas.

25. Method according to claim 23, or 24, wherein said injecting comprises forming a thermic protection barrier for said web material.

26. Method according to claim 23, or 24, wherein said advancing comprises advancing said web material in the form of a continuous film.

27. Method according to claim 23, wherein said heating comprises moving at least one heating element of said heating device between a first position in which said at least one heating element is in contact with, or very close to, said web material, and a second position, in which said at least one heating element is far from said web material.

28. Method according to claim 23, wherein said advancing comprises indexing said web material.

29. Method according to claim 28, wherein said injecting takes place during a stop of said indexing.

30. Method according to claim 23, wherein during said advancing there is provided interposing separating elements between portions of said web material.

31. Method according to claim 30, wherein before said advancing there is provided folding said web material along a longitudinal direction thereof to obtain said portions.

32. Method according to claim 24, wherein said injecting comprises injecting said cooling gas along a direction transversally oriented with respect to said advancing direction.

33. Method according to claim 23, wherein said injecting comprises injecting said cooling fluid from above with respect to said web material.

34. Method according to claim 23, wherein said injecting comprises injecting said cooling fluid from below with respect to said web material.

35. Apparatus for forming containers, comprising advancing arrangement for advancing web material along an advancing direction across at least one heating station provided with heating device and a forming station for forming containers from said web material and further comprising injecting device for injecting cooling fluid between said web material and said heating device.

36. Apparatus according to claim 35, wherein said injecting device is shaped in such a way that the cooling fluid exiting therefrom forms a thermic protection barrier for said web material.

37. Apparatus according to claim 35, or 36, wherein said heating device is provided with at least one heating element movable between a first position, in which said at least one heating element is in contact with, or close to, said web material and a second position, in which said at least one heating element is far from said web material.

38. Apparatus according to claim 35, wherein said injecting device is arranged below said web material.

39. Apparatus according to claim 35, wherein said injecting device is arranged above said web material.

40. Apparatus according to claim 35, wherein said injecting device comprises one or more outlets for said cooling gas arranged parallelly to said web material.

41. Apparatus according to claim 35, and further comprising separating arrangement arranged for separating opposing portions of said web material.

42. Apparatus according to claim 41, and further comprising folding device arranged for folding said web material to obtain said opposing portions.

43. Apparatus according to claim 40, or 41, wherein said separating device is so arranged as to face said heating device.

44. Apparatus according to claim 35, wherein said heating device comprises a heat-sealing device arranged for heat-sealing said web material.
